(19) United States
(12) Patent Application Publication
(10) Pub. No.: US 2005/0002204 A1
(43) Pub. Date: Jan. 6, 2005

(54) Module for uniforming light

(76) Inventors: Kun-Lung Lin, Hsinchu Hsien (TW); Min-Chieh Chou, Chutung Town (TW)

Correspondence Address: KNOBBE MARTENS OLSON & BEAR LLP, 2040 MAIN STREET, FOURTEENTH FLOOR, IRVINE, CA, 92614, US

(21) Appl. No.: 10/638,824

(22) Filed: Aug. 11, 2003

(30) Foreign Application Priority Data
Jul. 4, 2003 (TW) 92118414

(51) Int. Cl. F21V 7/04

(52) U.S. Cl. 362/551; 362/555; 362/561; 362/31; 362/30

(57) ABSTRACT

A module for equalizing light in liquid crystal display, having a light source and at least one gapless microlens array, is described. The gapless microlens array has a substrate and a plurality of bumps located on the substrate, and the bumps are connected closely with each other so that there is no gap between the bumps. Light is gathered, equalized and diffused by using the gapless microlens array.

### FIELD OF THE INVENTION

The present invention relates to a back light module of a panel, and more particularly to a module for equalizing light.

### BACKGROUND OF THE INVENTION

User demand for entertainment equipment is particularly high as a result of the rapid development of multimedia applications. Conventionally, the cathode ray tube (CRT) display, which is a type of monitor, is commonly used. However, the cathode ray tube display does not meet the needs of multimedia technology because of the large volume thereof. Therefore, many flat panel display techniques such as liquid crystal display (LCD), plasma display panel (PDP), and field emission display (FED) have been recently developed. Of these techniques, the liquid crystal display (LCD) is attracting attention in the field of displays as a full-color display apparatus.

The LCD (Liquid Crystal Display) is a planar display with low power consumption. In comparison with the CRT (Cathode Ray Tube) of the same screen size, the LCD is much smaller in its space occupation and weight. Unlike the curved screen in conventional CRTs, it has a planar display screen. With these advantages, LCDs have been widely used in various products, including palm calculators, electronic dictionaries, watches, mobile phones, notebook computers, communication terminals, display panels or even personal desktop computers.

A conventional back light type LCD comprises a front-end liquid crystal panel and a back-end back light module. Therefore, a large back light module is required for providing enough illumination to pass through the liquid crystal layer to show the information of the LCD. Typically, fluorescent lamps are used as the back light source. The light passes through a back light film to provide uniform illumination of the liquid crystal panel.

FIG. 1 illustrates a cross-sectional view of a conventional back light module. The main components of the back light module 10 comprise a light source 12, a light guide 14, a diffusion sheet 16 and a brightness enhancement film 18. The operation method of the conventional back light module 10 is to use this light guide 14 to lead the light 12 to pass through the optical films to generate a uniform light. Typically, a lamp, light emitting diode (LED) or cold cathode fluorescent lamp (CCFL) can be used as the light 12 of the back light module 10. Generally, a large-sized panel always uses a CCFL as the back light source because the CCFL has inherent advantages, such as a long life span and high illuminating efficiency. On the other hand, the LED is a suitable back light source for a small size panel.

The light guide 14 is used to guide the light 12. The brightness enhancement film 18 can be a prism made of a resin material. A sawtooth-shaped resin is formed over a substrate to generate a spotlighting efficiency. A 60% brightness efficiency can be increased by assembling the brightness enhancement film 18 in the back light module 12. Moreover, a reflective plate 22 is assembled on the other side of the light 12, which also can increase the brightness efficiency. Typically, a protective plate 20 is assembled on the top of the back light module 10 to protect the optical components thereof.

There are two types of the back light module, edge-side type and direct type. FIG. 1 illustrates the structure of the direct type back light module. FIG. 2 illustrates the structure of the edge-side type back light module. The main difference between the two types of back light modules is that the light 12 is located on the side of the light guide 14 in the edge side type back light module. Typically, only one CCFL is located on the side of the edge side type back light module to serve as the light 12. A V-shaped light guide 14 and a reflective plate 22 are used in this module to reflect the light uniformly into the module. Such structure can reduce the thickness of the back light module. Therefore, the structure is suitable for use in a notebook. However, it is difficult to get a uniform brightness in this structure. The light 12 is located on the bottom in the direct type back light module. This type of back light module uses at least two lamps and this structure provides a brighter light. The power consumption, however, is also increased. The thickness of the back light module is also increased. Therefore, this structure is suitable for a LCD monitor or a LCD television.

### SUMMARY OF THE INVENTION

According to the above descriptions, the conventional optical films in a back light module include a light guide, a diffusion sheet and a brightness enhancement film. This structure can cause a situation where the light is absorbed and reflected among these optical films, which degrades the brightness of the light.

Therefore, the main object of the present invention is to provide a module for equalizing light in a liquid crystal display. A gapless microlens array is used to form a gapless microlens structure, which can get a better efficiency for collecting and equalizing light efficiency.

Another object of the present invention is to provide a module for equalizing light in a liquid crystal display. A gapless microlens array replaces the conventional diffusion sheet or the brightness enhancement film.

Accordingly, the uniform light module of the present invention comprises a light source and a gapless microlens array. The gapless microlens array is used to equalize the light. The array is composed of a substrate and a plurality of bulges located on the substrate. These bulges are connected together and there are no spaces between them.

According to the preferred embodiment of the present invention, the gapless microlens array is formed of a macromolecular transparent material, such as Polyimide (PI), Polymethyl Methacrylate (PMMA) and Polycarbonate (PC). The top view of the bugle can be a hexagon, a square, a polygon or a combined structure. The gapless microlens array replaces the conventional diffusion sheet or brightness enhancement film. However, the diffusion sheet or the brightness enhancement film also can be assembled on the back light module of the present invention when necessary. Moreover, a prism or brightness-enhancing structure also can be assembled on the back light module to increase the light collection efficiency.

The uniform light module reduces the components of the back light module. The energy degradation due to the absorption or reflection of the components can be reduced. Therefore, the brightness efficiency can be increased. Moreover, the ease of assembling this structure makes the back light module smaller and cheaper.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the structure of the direct-type back light module;

FIG. 2 illustrates the structure of the edge side-type back light module;

FIG. 3 illustrates a cross-sectional diagram of the gapless microlens array of the present invention;

FIG. 4 illustrates a top view diagram of the gapless microlens array according to the first embodiment;

FIG. 5 illustrates a top view diagram of the gapless microlens array according to the second embodiment;

FIG. 6 illustrates a cross-sectional diagram of a three-dimensions gapless microstructure array model used to manufacture the gapless microlens array according to the preferred embodiment of the present invention; and

FIG. 7 and FIG. 8 respectively illustrates a schematic diagram of using the gapless microlens array in the back light module of a liquid crystal display according to the preferred embodiment of the present invention.

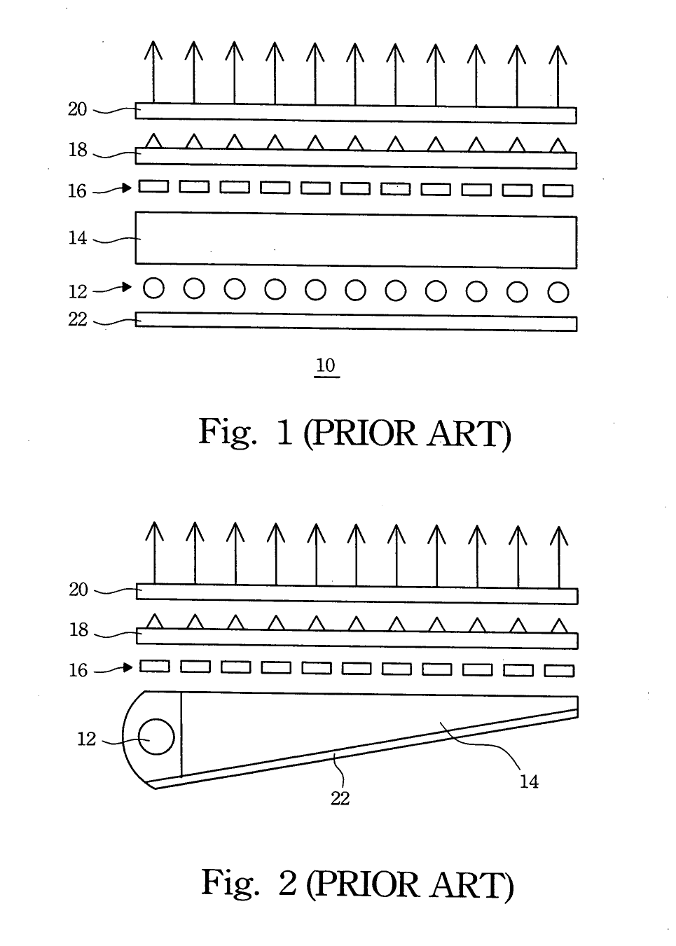

### DETAILED DESCRIPTION OF THE PREFERRED EMBODIMENT

The present invention provides a uniform light module with one or more one gapless microlens array.

Microlenses are widely used in the optical fiber, optical communication and optical electrical products. For example, a microlens is assembled in the end terminal of the optical fiber to collect light. However, some gaps exist between the microlens of the microlens array, which can affect the dots per inch.

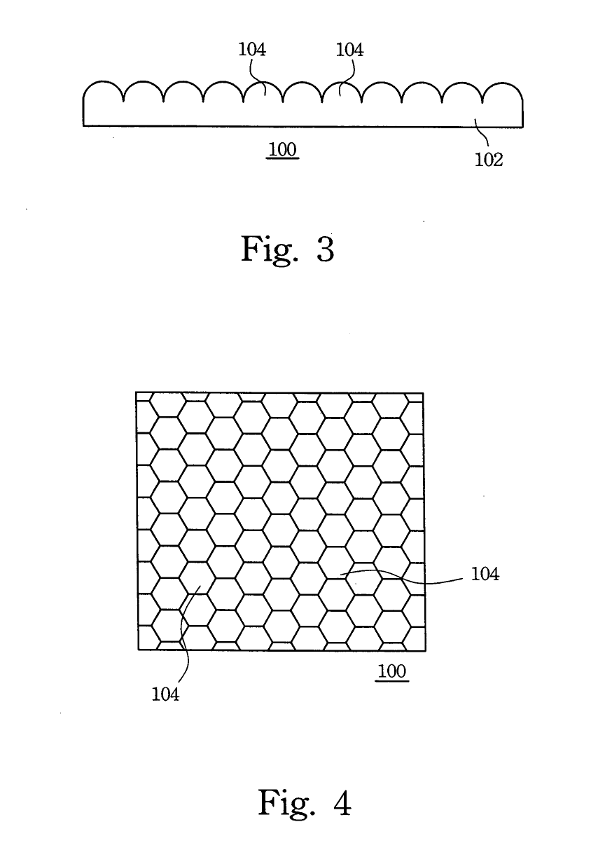

Therefore, the present invention uses a gapless microlens array to solve the above problem. FIG. 3 illustrates a cross-sectional diagram of the gapless microlens array of the present invention. Referring to FIG. 3, the gapless microlens array 100 of the present invention comprises a substrate 102 and a plurality of bulges 104 located on the substrate 102. These bulges are connected together. In other words, there are no spaces between these bulges.

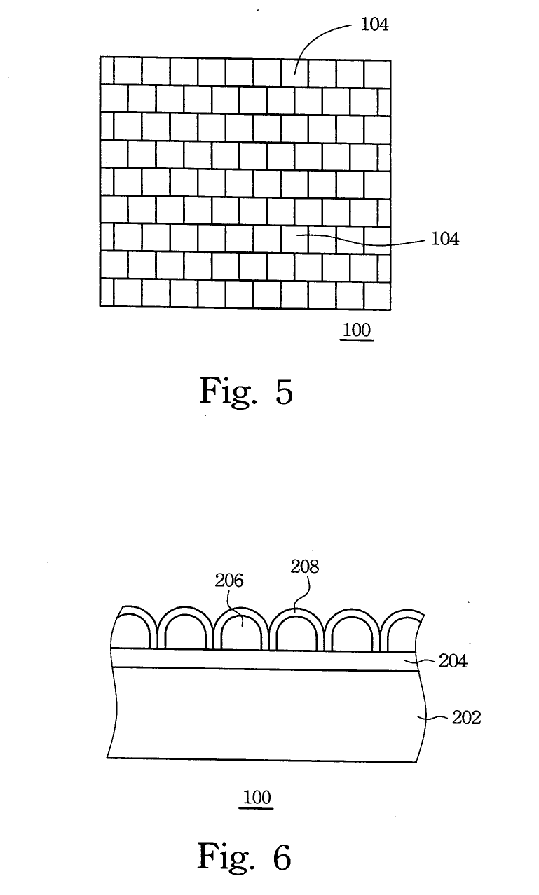

According to the preferred embodiment, the preferred cross-sectional view of the bulge 104 is a ball and similar lens structure. Therefore, light collection and equalization are improved. The top view of the bugle 104 can be a hexagon as shown in FIG. 4 or a square as shown in FIG. 5. This is because a hexagon or a square structure can fit tightly between the bulges 104. However, other structures can also be used in the present invention.

For achieving mass production, micro injection forming technology, micro pressure forming technology or UV light forming technology are used in the present invention to form the gapless microlens array. The metal model used in the micro injection forming technology or micro pressure forming technology is a three-dimensions microstructure array model. This model is formed by an electroform or a discharge working technology. FIG. 6 illustrates a cross-sectional diagram of a three-dimensions gapless microstructure array model used to manufacture the gapless microlens array according to the preferred embodiment of the present invention. The following paragraphs describe the manufacturing method.

Referring to FIG. 6, the manufacturing method of the three-dimensions gapless microstructure array model 200 first adopts a spin coating technology to form buffer layer 204 over the substrate 202. The material for forming the buffer layer 204 can be a Polyimide or a Polyamide. Next, a photoresist layer is formed over the buffer layer 204. Then, a photolithography process is performed to pattern the photoresist layer. A thermal process is performed to heat the substrate 202 until the temperature of the photoresist material is higher than the glass transforming temperature. At this time, the photoresist material is melted to form the bumps 206 on the buffer layer 204. The preferred photoresist material is a material with a glass-transforming temperature of about 100° C. to 350° C., such as Polymethyl Methacrylate. After that, a sputtering process is performed to form a conductive metal layer (not shown in the figure) over the bumps 206. Next, another metal layer 208 is formed over the bumps 206. This metal layer 208 is used to eliminate the spaces between the bumps 206. The material for forming the conductive metal layer can be copper. The material for forming the metal layer 208 can be nickel. This method provides a more precise structure. After the three-dimensional gapless microstructure array model 200 is finished, manufacture of a gapless microlens array can start.

The gapless microlens array of the present invention is manufactured by micro injection forming technology, micro pressure forming technology or UV light forming technology. According to the preferred embodiment of the present invention, the gapless microlens array can be formed from a macromolecular transparent material, such as the Polyimide (PI), Polymethyl Methacrylate (PMMA) and Polycarbonate (PC). The gapless microlens array of the present invention has a better light diffusion efficiency, which can uniformly diffuse the light. Moreover, the bulges can be used as the lens, which can improve the light collection efficiency. In other words, the gapless microlens array can replace the diffusion sheet or the brightness enhancement film in the conventional back light module. Moreover, the different appearances and the different curves of the bulges can provide brightness efficiency and scattering efficiency. The user can change the appearance or the curve ratio according to the requirement. Generally, when the distribution of the bulges is more highly concentrated, light collection and equalization is improved.

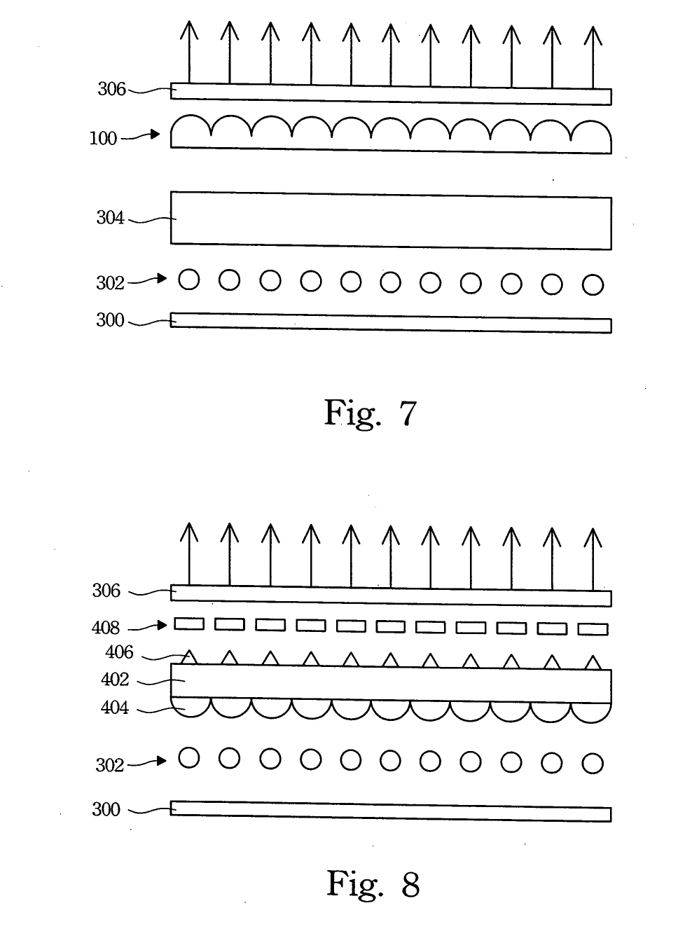

FIG. 7 illustrates a schematic diagram of using the gapless microlens array in the back light module of a liquid crystal display according to the preferred embodiment of the present invention. Referring to FIG. 7, a light guide 304 is located over the light source 302 to lead the light into the back light module. However, in another embodiment, the light guide 304 can also be removed. A plurality of CCFL can be used to serve as the light source 302. A reflective plate 300 is used to enhance the light. The gapless microlens array 100 of the present invention is assembled in the above of the light guide 304. The gapless microlens array 100 can be assembled toward or away from the light guide 304 in the back light module. Moreover, a protective plate 306 is assembled in the top of the back light module to protect this module. In accordance with the preferred embodiment, the gapless microlens array 100 can concentrate the light 302 led by the light guide 304 between positive and negative about 17 degrees that the liquid crystal display can accept.

On the other hand, a plurality of gapless microlens arrays 100 also can be used in the back light module. Moreover, the gapless microlens arrays 100 can also be used with a conventional diffusion sheet, a brightness enhancement film or prism for different optical products. When a diffusion sheet is assembled into the back light module, the location of this diffusion sheet is over the gapless microlens arrays 100 of the FIG. 7. In other words, the location is between the protective plate 306 and the gapless microlens arrays 100. When a brightness enhancement film is assembled into the back light module, the location of this brightness enhancement film is under the gapless microlens arrays 100 of the FIG. 7. In other words, the location is between the light guide 304 and the gapless microlens arrays 100. Generally, the brightness enhancement film is a prism or a cylinder structure. The principle of the brightness enhancement film is well known in the art, and is not further explained here.

On the other hand, the substrate for forming the gapless microlens array can not only form the bulges on one side but also form the other structure on the other side. Referring to FIG. 8, bulges 404 are formed on one side of the substrate 402 and the other microstructure 406 are formed on the other side of the substrate 402. The microstructure can be the gapless structure as described above to improve the brightness. Moreover, the material of the substrate 402 can be the material forming the light guide for simplifying the components in the back light module. On the other hand, a diffusion sheet 408 also can be assembled into the back light module as shown in the FIG. 8

The uniform light module with gapless microlens array of the present invention can reduce the components required in the module. Therefore, the volume of the back light module can be reduced. Moreover, the energy degradation due to the absorption or reflection of the components can be reduced. Therefore, the brightness efficiency can be increased. Moreover, the ease of assembling easily assembling can help the back light module to reduce volume and cost.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

1. A module for equalizing light, said module comprising:
a light source for generating a light; and
a gapless microlens array for equalizing said light, wherein said gapless microlens array comprises:
a substrate; and
a plurality of bulges located on said substrate, wherein said bulges are connected together.

2. The module according to claim 1, wherein the material for forming said gapless microlens array is a macromolecular transparent material.

3. The module according to claim 2, wherein said macromolecular transparent material is selected from a group consisting of a Polyimide (PI), Polymethyl Methacrylate (PMMA) and Polycarbonate (PC).

4. The module according to claim 1, wherein a top view of the bulges is a hexagon.

5. The module according to claim 1, wherein a top view of the bulges is a square.

6. The module according to claim 1, wherein said module further comprises a light guide located between said light source and said gapless microlens array.

7. The module according to claim 1, wherein said module further comprises a diffusion sheet located on a side of said gapless microlens array, and said gapless microlens array is located between said light source and said diffusion sheet.

8. The module according to claim 1, wherein said module further comprises a brightness enhancement film located between said light source and said gapless microlens array.

9. The module according to claim 8, wherein said brightness enhancement film is a prism.

10. The module according to claim 8, wherein said brightness enhancement film is a cylinder mirror.

11. The module according to claim 1, wherein a plurality of microstructures is located on another surface of said substrate.

12. The module according to claim 1, wherein said substrate is a light guide.

13. The module according to claim 1, wherein said module further comprises a reflective plate located on a side of said light source, and said light source is located between said reflective plate and said gapless microlens array.

14. A back light module, said back light module comprising:
a reflective plate;
a cold cathode fluorescent lamp located over said reflective plate;
a light guide located over said cold cathode fluorescent lamp;
a gapless microlens array located over said light guide, wherein said gapless microlens array comprises:
a substrate; and
a plurality of bulges located on said substrate, wherein said bulges are connected together; and
a protective plate located over said gapless microlens array.

15. The back light module according to claim 14, wherein said cold cathode fluorescent lamp is located under said light guide.

16. The back light module according to claim 14, wherein said cold cathode fluorescent lamp is located in a side of said light guide.

17. The back light module according to claim 14, wherein a top view of the bulges is a hexagon.

18. The back light module according to claim 14, wherein a top view of the bulges is a square.

19. The back light module according to claim 14, wherein said back light module further comprises a diffusion sheet located between said protective plate and said gapless microlens array.

20. The back light module according to claim 14, wherein said back light module further comprises a brightness enhancement film located between said cold cathode fluorescent lamp and said gapless microlens array.

21. The back light module according to claim 1, wherein a plurality of prisms is located on another surface of said substrate.
